(19) United States
(12) Patent Application Publication
(10) Pub. No.: US 2009/0157618 A1
(43) Pub. Date: Jun. 18, 2009

(54) Entity networking system using displayed information for exploring connectedness of selected entities

(75) Inventor: Joseph Matheny, Santa Barbara, CA (US)

Correspondence Address: MINTZ LEVIN COHN FERRIS GLOVSKY & POPEO, ONE FINANCIAL CENTER, BOSTON, MA, 02111, US

(73) Assignee: Media Trust Co., Toronto (CA)

(21) Appl. No.: 12/002,985

(22) Filed: Dec. 18, 2007

(51) Int. Cl. G06F 17/30

(52) U.S. Cl. 707/3; 707/E17.014

(57) ABSTRACT

A framework and methodology providing for navigation of the connectedness of selected entities of a plurality of entities adapted for display on a user interface. The system and method can comprise a receipt module for receiving a first search request for determining a secondary entity of said plurality of entities in relation to a primary entity of said plurality of entities. The first search request includes at least one search parameter associated with the primary entity for use in determining the secondary entity from said plurality of entities. The system and method can further comprise a search module for determining the secondary entity as matching the first search request according to a predefined inclusion threshold and a generation module for generating a primary connection view including a domain having a plurality of sectors. The connection view can be used in providing a visual discernment by a user of a degree of relatedness between the primary entity and the secondary entity and a relationship between the secondary entity and each of the plurality of sectors, such that the secondary entity is positioned in the domain in one of the plurality of sectors and the primary entity is positioned in the domain in a position related to said each of the plurality of sectors. The system and method can further comprise a matching module for modifying the first search request as a second search request by substituting the determined secondary entity as a revised primary entity for the second search request, wherein a secondary connection view is generated as a navigation of the primary connection view such that the secondary connection view has the revised primary entity and at least one further secondary entity of said plurality of entities matching the second search request according to a corresponding predefined inclusion threshold.

### FIELD OF THE INVENTION

This invention relates to investigation of social networks through connections between various entities.

### BACKGROUND OF THE INVENTION

Use of the Internet is growing in popularity due to the ever-expanding placement of information that is accessible on-line through various search tools, such as search engines. Placement of media content, and other content such as advertisements (ads), on-line has grown in popularity due to advantages in revenue generation. Further, the Internet is fast becoming the primary information search tool for obtaining information about products, places, people, etc. Unfortunately, the Internet is also quickly becoming a casualty of it's own success due to unmanageable amounts of available data and the inability of users to receive desirable search results that are of use to the users.

One problem associated with Internet search methodologies is the undesirable volume of search results obtained through a seemingly directed search. The amount of information available on any particular topic can be overwhelming to even the most seasoned Internet searcher. Typically, search results are filled with voluminous information that may not be appropriate for the search context desired by the searcher. Further, the searcher may desire certain media types over others. Certainly, it is a disadvantage to the searcher to have to sift through volumes of search results that seemingly do not pertain to the interests/desires of the searcher. Further, it is problematic for a user to efficiently interpret and then navigate interconnections between individuals between objects, and between individuals and objects identified in the users search results.

### SUMMARY OF THE INVENTION

It is an object of the present invention to provide an entity navigation environment to obviate or mitigate at least some of the above-presented disadvantages.

Search results can be filled with voluminous information that may not be appropriate for the search context desired by the searcher. Certainly, it is a disadvantage to the searcher to have to sift through volumes of search results that seemingly do not pertain to the interests/desires of the searcher. Further, it is problematic for a user to efficiently interpret and then navigate interconnections between individuals between objects, and between individuals and objects identified in the users search results. Contrary to present systems there is provided a framework and methodology providing for navigation of the connectedness of selected entities of a plurality of entities adapted for display on a user interface. The system and method can comprise a receipt module for receiving a first search request for determining a secondary entity of said plurality of entities in relation to a primary entity of said plurality of entities. The first search request includes at least one search parameter associated with the primary entity for use in determining the secondary entity from said plurality of entities. The system and method can further comprise a search module for determining the secondary entity as matching the first search request according to a predefined inclusion threshold and a generation module for generating a primary connection view including a domain having a plurality of sectors. The connection view can be used in providing a visual discernment by a user of a degree of relatedness between the primary entity and the secondary entity and a relationship between the secondary entity and each of the plurality of sectors, such that the secondary entity is positioned in the domain in one of the plurality of sectors and the primary entity is positioned in the domain in a position related to said each of the plurality of sectors. The system and method can further comprise a matching module for modifying the first search request as a second search request by substituting the determined secondary entity as a revised primary entity for the second search request, wherein a secondary connection view is generated as a navigation of the primary connection view such that the secondary connection view has the revised primary entity and at least one further secondary entity of said plurality of entities matching the second search request according to a corresponding predefined inclusion threshold.

A first aspect provided is framework providing for navigation of the connectedness of selected entities of a plurality of entities adapted for display on a user interface, the system comprising: a receipt module for receiving a first search request for determining a secondary entity of said plurality of entities in relation to a primary entity of said plurality of entities, the first search request including at least one search parameter associated with the primary entity for use in determining the secondary entity from said plurality of entities; a search module for determining the secondary entity as matching the first search request according to a predefined inclusion threshold; a generation module for generating a primary connection view including a domain having a plurality of sectors, the connection view for use in providing a visual discernment by a user of a degree of relatedness between the primary entity and the secondary entity and a relationship between the secondary entity and each of the plurality of sectors, such that the secondary entity is positioned in the domain in one of the plurality of sectors and the primary entity is positioned in the domain in a position related to said each of the plurality of sectors; and a matching module for modifying the first search request as a second search request by substituting the determined secondary entity as a revised primary entity for the second search request;

wherein a secondary connection view is generated as a navigation of the primary connection view such that the secondary connection view has the revised primary entity and at least one further secondary entity of said plurality of entities matching the second search request according to a corresponding predefined inclusion threshold.

A second aspect provided is method providing for navigation of the connectedness of selected entities of a plurality of entities adapted for display on a user interface, the method comprising: receiving a first search request for determining a secondary entity of said plurality of entities in relation to a primary entity of said plurality of entities, the first search request including at least one search parameter associated with the primary entity for use in determining the secondary entity from said plurality of entities; determining the secondary entity as matching the first search request according to a predefined inclusion threshold; generating a primary connection view including a domain having a plurality of sectors, the connection view for use in providing a visual discernment by a user of a degree of relatedness between the primary entity and the secondary entity and a relationship between the secondary entity and each of the plurality of sectors, such that the secondary entity is positioned in the domain in one of the plurality of sectors and the primary entity is positioned in the domain in a position related to said each of the plurality of sectors; modifying the first search request as a second search request by substituting the determined secondary entity as a revised primary entity for the second search request; and generating a secondary connection view as a navigation of the primary connection view such that the secondary connection view has the revised primary entity and at least one further secondary entity of said plurality of entities matching the second search request according to a corresponding predefined inclusion threshold.

### BRIEF DESCRIPTION OF THE DRAWINGS

Exemplary embodiments of the invention will now be described in conjunction with the following drawings, by way of example only, in which:

FIG. 1 is a block diagram of components of an entity navigation system;

FIG. 2 shows an example connection view generated by the system of FIG. 1;

FIG. 3 shows a further example connection view generated by the system of FIG. 1;

FIG. 4 shows example profiles of the content objects of the connection views of FIGS. 2 and 3;

FIG. 5 is a block diagram of an example computing device for implementing the components of the system of FIG. 1;

FIG. 6 shows a further example connection view generated by the system of FIG. 1;

FIG. 7 is a block diagram of an entity navigation framework of the system of FIG. 1;

FIG. 8 is a flowchart of operation of the framework of FIG. 7.

### DETAILED DESCRIPTION OF THE PREFERRED EMBODIMENT(S)

### Entity Networking System 10

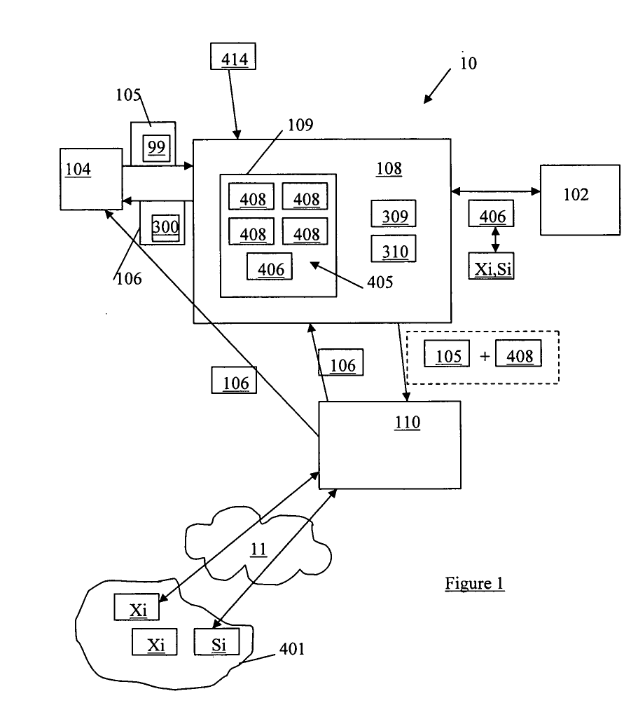

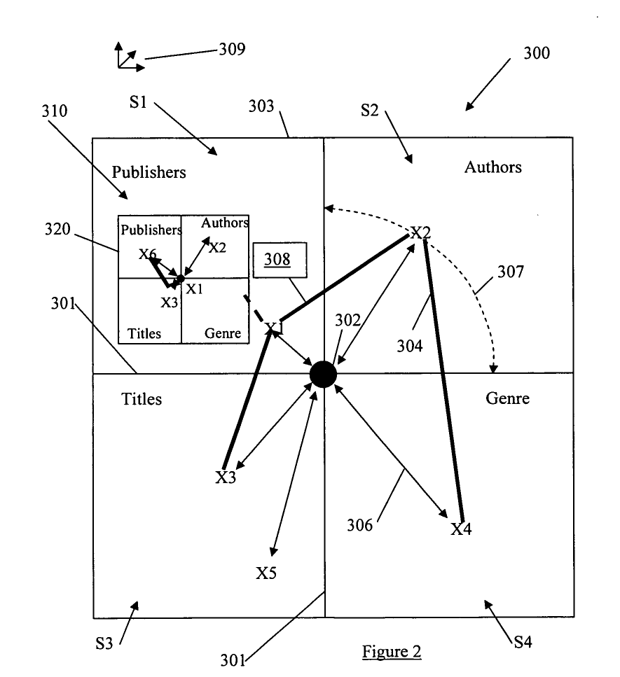

Referring to FIGS. 1 and 2, shown is an entity network navigation system 10 for providing search results 106, to a user 104, based on one or more search requests 105. The search results 106 can include a connection view 300 of all appropriate secondary entities Xi that are considered a match by an entity framework 108 to the search request 105, based on a primary entity 302. The user 104 can also be a registered entity of the framework 108 or can otherwise register with the framework 108 as part of the submission process for an initial search request 105. The search request 105 of the user 104 includes search parameters 99 (e.g. keyword terms, phrases, etc.) for use in helping to identify selected secondary entities Xi from a group 401 of available entities/sectors, as well as any sectors Si from the group 401 of available entities/sectors if applicable. The connection view 300 also contains displayed interconnections 304 between secondary entities Xi as well as visual indications of the degree of relatedness/matching of the secondary entities Xi with respect to the primary entity 302 and/or the sectors Si of the connection view 300, as further described below. It is recognised that selected sectors Si can be included as part of the search request 105 and/or some definitions (e.g. keywords) for use in matching potential sectors Si. In any event, it is recognised that the connection view 300 generated by the entity framework 300 can include the primary entity 302, a plurality of secondary entities Xi, and one or more sectors Si used to provide visual context for the entities 302, Xi, as further described below.

### Search Request 105

The entities 302, Xi can include other users 104 (e.g. people, named organizations, etc.) as well as media such as but not limited to: image files; video files; audio files; text/literary files; critiques on various media (e.g. article/book reviews); Web pages/sites; electronic documents; online advertisements; blogs; and/or podcasts. The user 104 submits the search request 105 to the entity framework 108 over a network (e.g. network 11) in order to locate desired secondary entities Xi that are potentially related to the primary entity 302, through matching of at least some of the search parameters 99, e.g. the user 104 wants to locate all secondary entities Xi including books and articles related to a selected interests (e.g. selected sectors Si) of the user 104 (e.g. as the primary entity 302). It is recognised that at least some of the entities Xi of the group 401 are registered with the entity framework 108, as further described below. It is also recognised that the tags 405, see below, of the primary entity 302 can be considered by the framework 108 as part of the search request 105, as explicitly provided search parameters 99 and/or as implicitly associated by the framework 108 (e.g. the framework 108 assigns private tags 408).

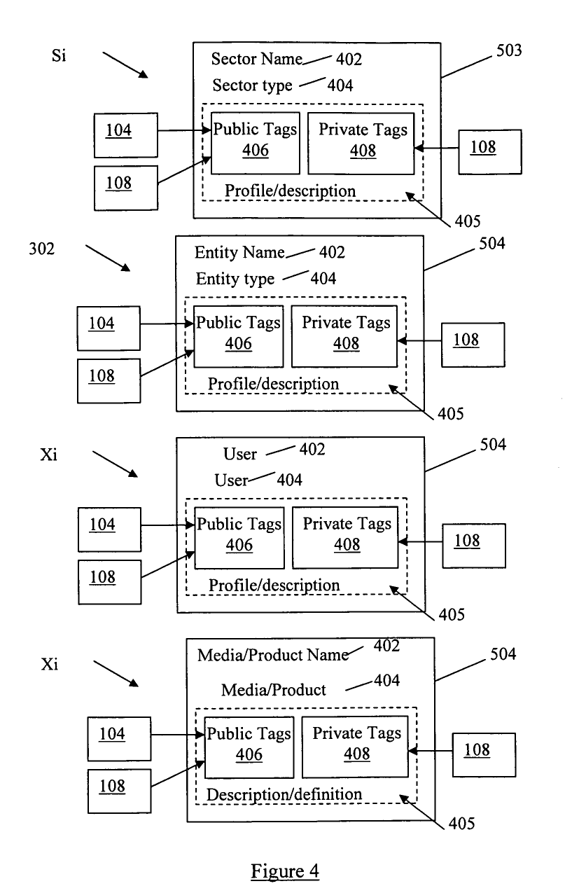

Further, it is recognised that profiles 503,504 (see FIG. 4), or portions thereof) can be included or otherwise combined with the search request 105 submitted. For example, information from the profile 503,504, used to supplement the search request 105, can include public and/or private tags 405 associated with the primary entity 302. Further, it is recognised that in the case where the primary entity 302 does not represent the user 104 submitting the request 105, profile 503,504 information used to supplement the request 105 can include information such as but not limited to: user profile 504 information, primary entity profile 503,504 information; or a combination thereof.

For example, the user 104 first submits a request 105 using the user 104 as the primary entity 302, such that the framework 108 supplements the search request 105 using information obtained from the profile 504 of the user 104. The search results 106 could identify another person (i.e. secondary entity Xi), which the user 104 then selects as the primary entity 302 for a new search request 105 for processing by the framework 108. One option is where the new search request 105 contains the same parameters 99 as the original search request 105, however the framework 108 substitutes the profile 504 information of the other person for the profile 504 information of the user 104, thus supplementing the parameters 99 of the search request 105. In this manner, the search results 106 would be generated from the perspective of the other person (as if the other person actually submitted the search request 105) such that the resultant connection view 300 would be the same as if the other person submitted these same search parameters 99 to the framework 108 (i.e. was the user 104 submitting the search request 105). Another option, is for retaining the profile 504 of the user 104 and ignoring the profile 504 of the secondary entity Xi selected as the new primary entity 302), and thereby executing the original search 105 but with the secondary entity Xi selected as the now primary entity 302.

It is also envisioned that the search parameters 99 could be changed as well, when submitting the new search request 105 with the secondary entity Xi selected as the primary entity 302. Further, it is also envisioned that the information from both of the profiles 504 (of the user 104 and the selected secondary entity Xi) could be used to supplement the search request parameters 99, as desired.

### Tags 405

The entity framework 108 can also be used to coordinate the association of tags 405 (see FIG. 1) with each of the entities 302, Xi and sectors Si, or group of entities/sectors, such that the tags 405 and the search parameters 99 of the search request 105 are used to determine the best match (from the group 401) as selected secondary entities Xi. It is recognised that coordination of association of the tags 405 with the entities 302,Xi and/or sectors Si is facilitated through the use of profiles 503,504 (see FIG. 4), and if appropriate with suitable information known for the non-registered entities Xi that can be adapted for use in a tag 405 update process that assigns tags 405 to non-registered entities Xi, as further described below. It is also recognised that members/users 104 of the entity framework 108 can assign tags 405 to selected entities 302, Xi and/or sectors Si in their corresponding profiles 504,503, as well as the entity framework 108 can assign (independently of the members/users 104) the tags 405 to selected entities 302, Xi and/or sectors Si in their corresponding profiles 504,503.

The framework 108 has a table 109 (or other structured memory construct) for storing private/restricted access tags 408 (or information thereof and/or public/unrestricted access tags 406 that are associated with the secondary entities Xi, primary entities 302, and the sectors Si. It is recognised that the public tags 406 can provide identification, categorization, descriptive, and/or labelling information (for example) about the respective entity 302,Xi, such that access/knowledge to/of this public information can be made available to both the framework 108 (and members/users 104 thereof and individuals/organizations outside of the framework 108. For example, the user 104 could supply initial public tags 406 to the framework 108 for use in creating a user profile 504 (see FIG. 4). The user 104 would be allowed to subsequently monitor (add/modify/delete tags 406) or otherwise have knowledge of the contents of the public tags 406 contained in their respective profile 504. The user 104 could expect that the predefined public tags 406 would be actively associated/used with their profile 504 in the processing of the search requests 105, unless otherwise advised (e.g. by the framework 108). Similar access/knowledge to/of this public information is made available to both the framework 108 (including member users 104) and individuals/organizations (e.g. producers 102) outside of the framework 108 for public tags 406 associated with profiles 504 for all entities Xi, 302 and sectors Si (if applicable).

On the other hand, the private tags 408 represent tags 405 to which access/knowledge to/of is restricted in some manner, for those individuals/organisations outside of the framework 108 and to selected member/users 104 inside of the framework. The private tags 408 can also provide identification, categorization, descriptive, and/or labelling information (for example) about the respective entity 302/Xi and/or the respective sector Si. The framework 108 assigns these private tags 408 to a tag cloud/grouping 502 for each entity 400 and places a restriction on access/knowledge to/of the private tag 408 contents to the individual (e.g. user 104) and/or the organisation (e.g. producer 102) associated (e.g. owning or defined as having access to) with the defined entity profile 504. For example, based on user 104 interactions with selected entities Xi and/or sectors Si, the private tag 408 set in the tag cloud 502 of the user 104 would be updated to contain information about these interactions without direct knowledge of the user 104. It is recognised that the degree of restricted access to the private tag 408 information could be varied: such as but not limited to outright restricted access; full/limited access granted upon request of the user 104/organisation 102 to the framework 108; or a combination thereof. In the below described embodiment(s), access to the private tags 408 to those outside of the framework 108 is described as outright restricted access, by example only.

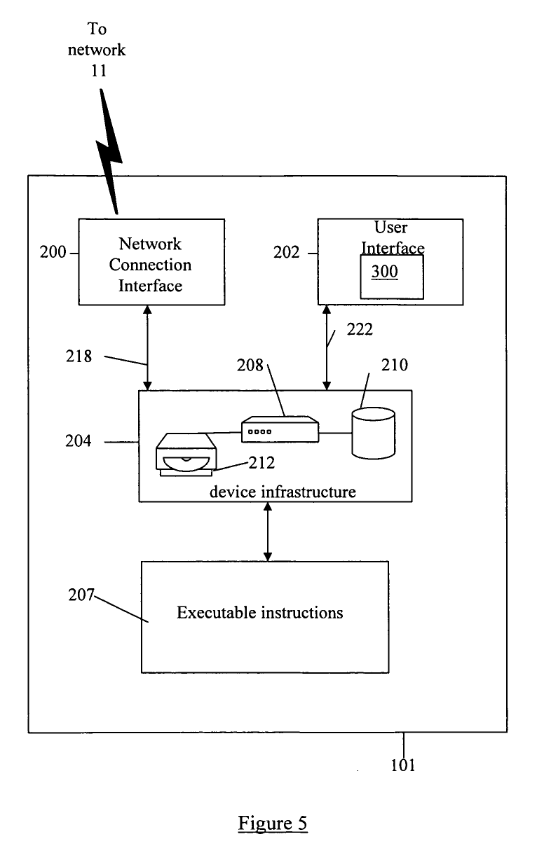

The table 109 of the framework 108 can be used to identify those private tags 408 associated with respective named entities 302,Xi and/or sectors Si. For example, table 109 can include private tags 408 that are associated with the identification (e.g. network URL) of a computing device 101 (see FIG. 5) that is registered to the user 104, as well as private tags 408 that are associated with the identifiers for known entities Xi (e.g. other users/people 104 and/or media). It is also recognised that the private tags 408 can be associated with the hosting devices 101 (e.g. URL) known to host certain entity Xi/sector Si types (e.g. book reviewers and reviews).

For example, the user 104 could have private tags 408 (i.e. unknown to the user 104) associated with their user profile 504 (see FIG. 4), for example indicating that the user 104 had accessed action movies from on-line video stores in the past month or is an avid participant in certain peer review Websites/groups. Accordingly, the framework 108 could modify the search request 105 (including the fact that the user 104 enjoys action movies and participates with peer review of action movies), as further described below, to include a preference for action movies (as evidenced through an assigned “action movie” and “peer reviewer” private tags 408 associated with the tag cloud 502 of the user 104), The inclusion of these private tags 408 could preferentially weight the search results 106 to include secondary entities Xi pertaining to action movies and/or movie reviews/reviewers or to otherwise rank such secondary entities Xi action movies more closely related to specific sectors Si and/or the primary entity 302. In general, the framework 108 can modify the search request 105 with the private tags 408 (associated with the profile 504 of the user 104 and/or selected entities Xi and/or sectors Si) in order to make the search results 106 more applicable to the primary entity 302. It is recognised that the private tags 408 can be assigned by the framework 108 to the user 104 profile 504 and/or to the descriptions/profiles 504 of other entities 302,Xi based on behavioural information 414 (see FIG. 1) related to the user 104 and/or that of other entities Xi/sectors Si connected with those entities Xi and/or sectors Si, as further described below.

### Behavioural Information 414

This behavioural information 414 is obtained (for example periodically) and is analysed to generate (manually or automatically) keywords/phrases used to create or otherwise dynamically amend the private tags 408 pertaining to the entity 302,Xi and/or sectors Si associated with the behavioural information 414. Examples of the behavioural information 414 can include information such as but not limited to: on-line browsing history, consumer profiles from third party programs (e.g. reward programs); consumer surveys; and search request 105 history. For example, the search request 105 history could be monitored by an update module 410 for all search terms 99 (see FIG. 1) used by a particular user 104, as well as which of secondary entities Xi are selected from the connection view 300 of the search results 106. These search terms 99 as well as the particular entities Xi selected, for example, would be used to generate appropriate private tags 408 for the user 104 (originator of the search request 105) and/or to the primary entity 302 if not the user 104. As well, analysis of the search request 105 history could be used to update the tags 405 of the entities Xi, 302 (e.g. media and/or other users 104) that were included in the search results 106.

For example, the behavioural information 414 known about non-registered entities 400 can be used to create a profile 504 and corresponding tag cloud 502 for use by the framework 108, as desired. This creation of the tag cloud 502 for the non-registered entities 400 can be done during generation of the search result 106 or can be done after generation of the search result 106. Further, it is recognised that identification of the non-registered entities 400 present in the search results 106, obtained by a search module 410 (see FIG. 5), can be used to initiate the registration of the identified non-registered entities 400 in the search results 106 (e.g. by noting that certain entities 400 in the search results 106 do not have a corresponding entity identifier 402 (see FIG. 4) stored in the memory 210.

The framework 108 can include a search engine (not shown) or can interact with a third party search engine 110 to determine the selected entities Xi and/or sectors Si based on the tags 405 and the search parameters 99. Also included is a producer 102 that is responsible for making available the entities Xi (e.g. media files, blogs, etc.) through the hosting devices 101, as well as for defining/suggesting public tags 406 for the profile 504 (see FIG. 4) for each entity Xi and/or sector Si, to assist in matching of the secondary entities Xi and/or sectors Si to the search request 105. It is recognised that the producers 102 (and users 104) only have access/knowledge to public 406 rather than private 408 tags, as further described below.

Communication between the producer 102, the framework 108, the user 104, the search engine 110 and devices 101 (see FIG. 2) hosting the entities Xi is facilitated via one or more communication networks 11 (such as intranets and/or extranets—e.g. the Internet). The entity navigation system 10 can include multiple producers 102, multiple users 104, multiple search engines 110, multiple hosting devices 101, and one or more coupled communication networks 11, as desired.

### Connection View 300

### Displayed Objects 310

The connection view 300 contains displayed objects 310 such as but limited to; a plurality of secondary entities Xi, sectors Si, and interconnections 304 (see FIG. 2). It is recognised that these objects 310 in the connection view 300 can include definitions using hypertext. The objects 310 can include selectable connections from one word, picture, or information object to another. In a multimedia environment such as the Internet, such objects 310 can include sound and motion video sequences, as well as still pictures and electronic text. One example form of the objects 310 is a highlighted word or picture/icon that can be selected by the user 104 (with a mouse or in some other fashion), resulting in the delivery and view of another file obtained from one of the hosting devices 101. The highlighted object 310 can be referred to as an anchor, such that the anchor reference and the object referred to constitute the link. In Hypertext Markup Language (HTML), the anchor is the establishing of a term, phrase, image, or other information object as being either: the target of the hypertext link within a document, or a reference (a link you can select) to such a target. It is recognised that the objects 310 can include link mechanisms such as but not limited to: Inline Text Links; Text Banners; Graphical/Rich Media Banners; In-page Graphical Banner; Pop-Unders/Ups; XML Feeds; Layer Ads; and Search box, for example. Monitoring of the interaction of the user 104 with certain objects 310 can be used to identify behavioural information 414 of the user 104 (or users 104 associated with access to a particular entity Xi) and thus be used to update the private tags 408, as further described below. The behavioural information 414 can also be supplied to the framework 108 from third party suppliers (e.g. award programs, travel agencies, etc.) who monitor behaviour (e.g. purchase(s), travel, other activities such as hobbies, interests, etc.) of selected users 104 and their interaction with identified entities Xi and/or sectors Si.

Further, it is recognised that these objects 310 in the connection view 300 can be displayed using space saving, decluttering methods as is known in the art. For example, all of the secondary entities Xi within the boundary 303 could be displayed, however only initially with primary interconnections 304 between the primary entity 302 and some (e.g. selected by the user 104) or all of the secondary entities Xi. Subsequently, secondary interconnections 304 between a secondary entity Xi and associated entities Xi could be displayed in the connection view 300, when the secondary entity Xi (or group of entities Xi) is selected by the user 104.

### Sectors Si

Referring to FIG. 2, shown is an example of the connection view 300, provided by the framework 108 (see FIG. 1), as a result of the search request 105 from the user of the device 101. Displayed in the connection view 300 is at least one primary entity 302 and a plurality of secondary entities Xi (e.g. X1, X2, X3, X4, X5) related to the primary entity 302. The connection view 300 includes a series of sectors S1, S2, S3, S4 (e.g. Si) that divide up the domain of the connection view 300 into a plurality of defined regions that provide categories of interest/relatedness to the primary entity 302. The grouping of sectors Si defines an external boundary 303 (e.g. around the periphery of the group of sectors Si) of any applicable shape (e.g. consisting of arcuate and/or linear portions—circular, rectangular, square) as a polygon (either planar or multidimensional—e.g. 3D) that bounds the grouping of sectors Si by a closed path or circuit, composed of a finite sequence of straight line and/or arcuate segments, called edges or sides of the boundary 303. The point where two adjacent edges/sides meet can be referred to as a vertex or corner. The connection view 300 also has a series of internal boundaries 301 that define the visual separation between adjacent sectors Si. Accordingly, all displayed secondary entities X1 can be positioned between the boundaries 301, 303 of the connection view 300, thereby representing degrees of relatedness (e.g. similarity) between the secondary entities Xi and the primary entity 302 and degrees of relatedness/similarity between the secondary entities Xi and the sector(s) Si of the connection view 300.

For example, in FIG. 2, the external boundary 303 of the four sectors S1, S2, S3, S4 is shaped as a quadrilateral (e.g. square) and the internal boundaries 301 are two intersecting lines positioned at right angles with respect to one another, thus dividing the connection view 300 into four square shaped sectors Si as sub-regions of the connection view 300. The connection view 300 contains one primary entity 302 and five secondary entities X1, X2, X3, X4, X5, each of which is positioned with respect to the sectors S1, S2, S3, S4. The connection view 300 also contains interconnections 304 between one or more of the displayed secondary entities Xi, thus signifying that there is a known connection (e.g. degree of similarity) between the interconnected secondary entities Xi. For example, referring to FIG. 2: entity X1 is interconnected 304 with entity X3 and entity X2; entity X2 is interconnected 304 with entity X1 and entity X4,;entity X3 is interconnected 304 only with entity X1; entity X4 is interconnected 304 only with entity X2; and entity X5 is not interconnected with any of the other entities X1, X2, X3, X4. It is also recognised that each of the secondary entities Xi is related (have a degree of similarity) to the primary entity 302, as further described below.

### Entity 302, Xi Layout

Each of the secondary entities Xi can be positioned in the connection view 300 wholly within one of the sectors Si or on the border of two or more sectors Si. For example, secondary entity X2 is predominantly related to the sector S2 (e.g. entity X2 is predominantly characterized by the definition(s) of the sector S2 as compared to the definitions of the other sectors S1, S3, S4) and the entity X2 is therefore positioned within the sector S2. Further, in terms of the adjacent sectors S1 and S4, the entity X2 is positioned closer to the sector S1 than to sector S4 (e.g. along an arc 307—shown in ghosted view—of a constant radius from the center of the connection view 300), thus signifying that the entity X2 is better characterized by the definition(s) of the adjacent sector S1 over the definition(s) of sector S4. Further, it can be identified from the positioning of the entity X2 in the connection view that the entity X2 is least characterized by the definition(s) of the sector S3 in comparison to the definitions of the other sectors S1, S2, S4.

The degree of relatedness of the entities Xi displayed in the connection view 300 can be defined with respect to a scale 309 of the connection view 300. For example, the distance 306 can be defined as a percentage match (or other defined matching threshold 310—available to the framework 108, see FIG. 1), such that the scale 309 of the distance 306 could include: a zero/minimum value (e.g. signifying a 100% match between the particular secondary entity Xi and the primary entity 302) at one end of the distance scale 309 that could result in the display of the particular secondary entity Xi on top of the primary entity 302; and a maximum value (e.g. signifying a 0% match between the particular secondary entity Xi and the primary entity 302) at the other end of the distance scale 309 that could result in the display of the particular secondary entity Xi on the external boundary 303 (i.e. further way from the primary entity 302). It is recognised that the distance scale 309 can be defined other than as described.

Further, the scale 309 can also include inclusion thresholds 310 for the secondary entities Xi in the various sectors Si. For example, any match between a particular secondary entity Xi that matches less than a minimum number 310 of the definitions (e.g. tags 405) of a particular sector Si (or combination of sectors Si) would preclude the display of the particular secondary entity Xi in (or adjacent to) that particular sector(s) Si of the connection view 300. Further, the degree of match, if over the minimum threshold 310 for example, could be used by the framework 108 to position the particular secondary entity Xi with respect to the particular sector Si over other sectors Si. For example, referring to FIG. 2, given that: sector Publishers has five named publishers as sector tags 405, sector Authors has five named authors as sector tags 405; sector Titles has five named titles as sector tags 405; and sector Genre has five named genres as sector tags 405, the association of four authors—three publishers—two genres (e.g. as entity tags 405) with the secondary entity X2 (that match those same sector tags 405) would result in the secondary entity X2 being positioned predominantly in the sector Authors (i.e. having the most author matches 4/5) and nearer to the sector Publishers (i.e. having more publisher matches than genre matches—3/5 verses 2/5). As well, lets say that a secondary entity X6 had only one genre that matched, which was less than a minimum match threshold 310 of two genres). This would result in the secondary entity X6 not being displayed in the connection view 300. It is recognised that the degree of matching can be according to absolute numbers, a percentage of the total, and other matching methods as desired. Further, it is recognised that the matching thresholds 310 can be defined for each sector Si and/or a group of sectors Si, as desired. Further, it is recognised that there may be no matching threshold(s) 310 used (other than a zero match threshold 310), thus providing for the display of all secondary entities Xi in the context view 300 that match at least one search parameter 99 and/or sector Si definition.

Accordingly, positioning of the secondary entity Xi, with respect to the sectors Si, is used by the connection view 300 to visually represent the degree of similarity/relatedness of the secondary entity Xi with respect to the various sectors Si. In the exemplary case of entity X2, the entity X2 is most closely related to the sector S2 over the other sectors S1,S3,S4, then to the sector S1 over the other sectors S3,S4, then to the sector S4 over the other sector S3, and then lastly (or the least) related to the sector S3. Similarly, the degree of similarity of the other secondary entities Xi (e.g. X1,X3,X4,X5) with respect to the sectors Si can also be visually discerned via the positioning of these secondary entities Xi in the connection view 300.

The primary entity 302 is also positioned in the connection view 300 in a location that can be related to each of the sectors Si, e.g. in the center of the connection view 300 as shown by example. However, it is recognised that other locations of the primary entity 32, with respect to the locations of the boundaries 301,303), can be other than as shown, as desired. The connection view 300 can also provide a distinction between the differences in the degree of relatedness between each of the secondary entities Xi and the primary entity 302. For example, a distance 306 (e.g. measured radially from the primary entity 302) between the primary entity 302 and a particular secondary entity Xi can be used to visually signify the degree of relatedness between the primary entity 302 and the particular secondary entity Xi. For example, referring to FIG. 2, the secondary entity X1 is most closely related to the primary entity 302 (in view of the shortest distance 306) followed by the entity X3 followed by the entity X2 followed by the entity X4 and followed by the entity X5 (i.e. the least related out of all the secondary entities Xi with respect to the primary entity 302). It is also recognised that visual qualities of the secondary entities Xi (e.g. colour, size, shading, etc.) could be used to visually distinguish the relative degree of relatedness between each of the secondary entities Xi and the primary entity 302.

### Example Connection View 300

Accordingly, the connection view 300 is used by the framework 108 to visually represent the degree of relatedness, for example: between the secondary entities Xi and the primary entity 302; between the secondary entities Xi and each other; and/or between the secondary entities Xi and the various sectors Si. For example, the primary connection view 300 of FIG. 2 has four sectors Si, namely a first quadrant labelled Publishers (e.g. defined by a list of publishers), a second quadrant labelled Authors (e.g. defined by a list of authors), a third quadrant labelled Titles (e.g. defined by a list of titles), and a fourth quadrant labelled Genre (e.g. defined by a list of preferred genres). The primary entity 302 can represent a user (i.e. an individual) of the framework 108, the entity X1 represent a blog about literary works, the entity X2 represent another user of the framework 108, the entity X3 represent a particular book list, the entity X4 represent a particular book, and the entity X5 represent a book club (e.g. a group of users of the framework 108).

Upon inspection of the relative positioning of the secondary entities Xi within the sectors Si, one could visually discern that the blog X1 probably contains/refers to a larger degree/number of publishers (with respect to the definition of the sector Publishers) than the authors, titles, genre of their corresponding sector Si definitions. However, of the remaining sectors Si, the blog X1 also contains a greater degree/number of titles (hence positioned closer to sector Titles than sector Authors) than authors and a greater degree/number titles and authors than genre. Further, the blog X1 is also the closest (i.e. shortest relative distance 306) to the user 302 as compared to the other entities X2, X3, X4. Accordingly, the user 302 (upon inspection of the connection view 300) that the blog X1 is most closely related (e.g. having similar interests) to the user 302 out of all the secondary entities Xi and that this degree of relatedness concerns primarily the named publishers (of the sector Publisher definition) with secondary relatedness considerations of the named authors and titles (of the sector Titles and Authors definitions respectively). Also, the user 302 would be able to make the characterization that the book club X5 is least related to the user 302 (out of all the entities Xi displayed) and is mainly related with respect to similar titles (with respect to the definitions of the sector Titles) and next with respect to similar genre(s) (with respect to the definitions of the sector Genre).

Further, upon inspection of the interconnections 304 present in the connection view 300, one could make the characterization that: the user X2 is a member of the blog X1 (in view that the entity X1 is connected to the entity X2 by the displayed interconnection 304—e.g. a line); the book list X3 contains at least some of the publishers (present in the definitions of the sector Publishers) or that the blog X1 subscribes to or otherwise published the book list X3 (in view that the entity X3 is connected to the entity X1 by the displayed interconnection 304—e.g. a line); and the particular book X4 has been read by the user X2 or that a review of the book X4 has been published by the user X2 (in view that the entity X4 is connected to the entity X2 by the displayed interconnection 304—e.g. a line). Further, the user 302 could also make the characterization that the user X2 is not a published member of the book club X5, the book club X5 does not have any experience with the book X4, the book club X5 is not connected to the book list X3, and no members of the book club X5 participate in the blog X1. Accordingly, the displayed interconnections 304 provide for visual discernment of potential relations between the displayed secondary entities Xi. Further, it is also recognised that a descriptive summary 308 (e.g. via text and/or symbols/icons) of the interconnection 304 can be displayed (for example in response to a mouse-over or other user event 109 via a user interface 202—see FIG. 5) adjacent to the selected interconnection 304, thus facilitating an understanding of the interconnection 304 by the user of the device 101.

### Profiles 503, 504

Referring to FIG. 4, each of the sectors Si and the various entities 302, Xi has a defined profile 503 and a defined profile 504, respectively. These profiles 503,504 can be used to help the framework 108 (see FIG. 1) to determine the degree of match/relatedness: between the various secondary entities Xi and the sectors Si; between the secondary entities Xi and each other (e.g. whether there exists the interconnection 304—see FIG. 2—between two or more entities Xi); and/or between the secondary entities Xi and the primary entity 302. Accordingly, the profiles 503,504 are compared by the framework 108 (e.g. in view of the thresholds 310) in order to position the entities Xi, 302 in the connection view 300 (e.g. with respect to one another and with respect to the sectors Si). It is recognised that the framework 108 can also combine the search parameters 99 with the definitions of the profiles 503,504, in order to determine the degree of relatedness/match of the secondary entities Xi with the primary entity 302 in view of the thresholds 310.

The profiles 503,504 include the tags 405, which can also be combined with search parameters 99 of the search request 105 (see FIG. 1), which are used to determine the best match from the group 401 of available entities Xi of the environment 10), as selected ones of the secondary entities Xi. These selected entities Xi are then included in the connection view 300, depending upon the scale 309 of the connection view 300, which is also used to determine the relative positioning of the selected entities Xi in the connection view 300. The tags 405 can include public tags 406 and/or private tags 408, as further described below, which can be defined as a tag cloud 502.

### Tags 405

Referring again to FIG. 4, the tags 405 are single/multiple alpha and/or numeric descriptors (e.g. words) used to categorize or otherwise label content of the connection view 300 (e.g. entities Xi, 302 and sectors Si) so that the framework 108 (see FIG. 1) can match secondary entities Xi (with selected sectors Si and the primary entity 302) from the group 401 of available entities Xi (e.g. registered/defined entities Xi with the framework 108). The tags 405 are (relevant) keyword(s) or term(s) or phrases associated with or otherwise assigned to the entities Xi, 302 (e.g. users, pictures, articles, video clips, blogs, books, user groups, etc.) and sectors Si (e.g. entity categories such as publishers, authors, titles, genres, etc.), thus describing the entities Xi, 302 and sectors Si and enabling a descriptive/keyword-based classification of the entities Xi, 302 and sectors Si. The tags 405 can be metadata involving the association of descriptors with objects and can be embodied as the syntax (e.g. an HTML tag/delimiter such as a coding statement) used to delimit the start and end of an element, the contents of the element, or a combination thereof.

Referring again to FIG. 4, each of the entities Xi, 302 and sectors Si has associated with it one or more of the tags 405, as part of a predefined entity classification system/process 500. Each of the entities Xi, 302 and sectors Si can have the respective profile 504, 503 including an identifier 402 (e.g. name, URL, address, and other communication/contact information), a type 404 (e.g. user or other media such as audio, video, print, picture, etc.), and/or an associated tag cloud 502. It is recognised that the identifier 402 and the type 404 could be separate from and/or included as tags 405 in the tag cloud 502. The tag cloud 405 includes public tags 406 and optional private tags 408. The framework 108 accesses the tags 405 of the entities Xi, 302 and sectors Si (e.g. through the respective profile 504) in order to link/match those entities Xi, 302 and sectors Si that contain the tags 405 (or even to specified collections of tags 405) matching the parameters 99 of the initial search request 105 as well as the tags 405 of each other. It is noted that the tags 405 used in matching entities Xi, 302 and sectors Si to the search request 105 can be used in addition to the included search parameters 99 (see FIG. 1) of the search request 105. Further, it is recognised that the sectors Si may be obtained as part of the profile 503,504 matching process implemented by the framework 108 and/or particular sectors Si may be specified as part of the connection view 300 irrespective of the contents of the search parameters 99, as desired.

The tags 405 can be defined using a structured definition language such as but not limited to the Standard Generalized Markup Language (SGML), which defines rules for how a document can be described in terms of its logical structure (headings, paragraphs or idea units, and so forth). SGML is often referred to as a meta-language because SGML provides a “language for how to describe a language.” A specific use of SGML is called a document type definition (DTD), which defines exactly what the allowable language is. For example, Hypertext Markup Language (HTML) is an example of a structured definition language for defining the tags 405. A further example of the structured definition language is Extensible Markup Language (XML), which defines how to describe a collection of data. Accordingly, the tags 405 can be used to provide an underlying definition/description of the entities 400. For example, HTML delimiters can be used to enclose descriptive language (e.g. tags 405) about an HTML page, placed near the top of the HTML in a Web page as part of the heading.

There can be several kinds of tag 405 types useful for matching the sectors Si and/or secondary entities Xi, tags 405 such as but not limited to a keywords meta tag 405 and a description meta tag 405. The keywords meta tag 405 can be used to list the words or phrases that best describe the contents/attributes of the sectors Si and entities 302, Xi. The description meta tag 405 can be used to include a brief one- or two-sentence description of the sectors Si and entities 302, Xi. It is recognised that both the keywords and the description, of the tags 405, are used by the framework 108 to identify related sectors Si and entities 302, Xi appropriate to the search request 105 context. It is recognised that the description of the tags 405 may be included in the search results 106 (along with the generated connection view 300) to provide a summary of each of the sectors Si and entities 302, Xi returned in the search results 106. It is also recognised that the tags 405 can be used to help rank the sectors Si and entities 302, Xi with respect to other sectors Si and entities 302, Xi, as further described below with reference to the process 500. It is recognised for entities 302, Xi representing people (e.g. members of the framework 108), the tags 405 can be used to help define the profile 504 for the users 104.

### Tag 405 Examples

The following are example of tags 405 used to match entities Xi from the group 401 of entities Xi (and sectors Si from the group 401 of sectors Si) based on the search request 105 and/or profile 504 of the primary entity 302 upon which the search request 105 is based, and/or the profile 503,504 of the respective sectors Si and entities Xi in the group 401.

<META name=“resource-type” content=“document”>
the resource type tag 405 can include types such as but not limited to document, video, people, image, audio, blogs, etc.

<META name=“description” content=“a description of the sectors Si and entities Xi”>
the description type tag can be displayed along with the title of the sectors Si and entities Xi in an index. “content” could be a word, sentence or even paragraph to describe the sectors Si and entities Xi.

<META name=“keywords” content=“a, list, of, keywords”>
the keywords type tag 405 can include one or more descriptive keywords, separated by commas. The keywords can include synonyms, colloquialisms, and so on. For example, if the sectors Si and entities Xi are related to cars, the keyword tags 405 can include “car”, “cars”, “vehicles”, “automobiles”, autos, etc.

<M ETA name=“distribution” content=“one of several”>
the distribution type tag 405 can be used to list available resources to find things, such that the content should contain either global, local or IU (Internal Use).

Other examples of tags 405 include: a specific XML definition, such as Microsoft's Channel Definition Format (CDF), which defines a set of tags 405 for describing a Web channel; and an ID3 tag as a type of meta data container used to store information about an MP3 file (e.g. sectors Si and entities Xi such as a podcast) within the audio file itself. The ID3 tag 405 allows the creator of a file to embed relevant information (including hyperlinks and images) like the name of the artist, track title, album, track number and genre in the file, allowing that information to travel with the file. It is also recognised that the metadata can be defined as a set/list of descriptors (words, phrases, etc.) that are indexed or otherwise associated with the individual entities to comprise individual tags 405 or group tags 405, e.g. each word/phase is classified as a separate tag 405 and/or a group of words/phrases is classified as a single tag 405.

### Public 406 and Private 408 Tags

The framework 108 administers the association of the tags 405 to respective sectors Si and entities 302, Xi. It is recognised that either or both of the framework 108 and the producer 102 of the sectors Si and entities 302, Xi can assign the public tags 406 to the sectors Si and entities 302, Xi. For example, a blog containing articles on luxury automobiles could contain public tags 406 including descriptions of well-known luxury cars, keywords related to luxury car brands, etc, as provided to the framework 108 by the producer 102 of the blog (i.e. both the producer 102 and the framework 108 share knowledge of the producer 102 supplied public tags 406 for the respective entity 302,Xi). Another example is where the user 104 (e.g. also defined generically as one of the entities Xi,302) would supply the profile 504 description of themselves containing the public tags 406, e.g. user name, user age, user occupation, user geographic location, interests, etc. It is recognised the public tags 406 may or may not be shared with other producers 102/users 104 not associated with the entity 302,Xi, as desired. For example, user “A” may supply public tags 406 to the framework 108 for inclusion in their respective profile 504 (i.e. thereby setting up shared knowledge of the supplied public tags 406 between the framework 108 and the user A for it's profile 504). However, the framework 108 could restrict access to these public tags 406 by other users 104 (and/or producers 102, entities Xi, 302) not related to user “A”. Further, it is recognised that the search requests 105 and/or the corresponding search results 106 may also contain these public tags 406, but the actual identity of the user 104 (or identity of the producer 102 of the entities 302, Xi) make be kept, or otherwise obscured/aliased.

On the other hand, the private tags 408 are assigned to the sectors Si and entities 302, Xi by the framework 108 and are not made available/shared outside the framework 108. For example, the framework 108 restricts knowledge/access of the user 104 (or producer 102) for private tags 408 contained in the profile 504 of user 104, as well as restricts knowledge/access of the user 104 (or the producer 102) for private tags 408 contained in the description/definition profile 504 of sectors Si and entities 302, Xi. The private tags 408 are assigned to the sectors Si and entities 302, Xi by the framework 108 to help provide better context/sourcing for matching sectors Si and entities 302, Xi to one another. It is recognised that the assignment of private tags 408 by the framework 108 to respective sectors Si and entities 302, Xi can be done on a dynamic basis, e.g. for example for a specified update period such as a 90 day window, as further described below. The dynamic update of the private tags 408 can be the result of behavioural analysis of the sectors Si and entities 302, Xi for the specified update period, as further described below.

One example of private tags 408 are keywords that are representative of the character traits (e.g. behavioural information 414) of users currently accessing certain sectors Si and entities 302, Xi, which demonstrates monitoring of behavioural patterns with respect to the certain sectors Si and entities 302, Xi. For example, the framework 108 could note that a specific audio file (e.g. entity) is accessed predominantly by individual users that are known to be overweight and male. Accordingly, the keyword tags of “overweight” and “male” as behavioural information would be added by the framework 108 to the private tags 408 of the audio file. In the future, if tracking of access to the specific audio file (by the framework 108) notes that chronically overweight males and females are predominant, then the framework 108 would change the keyword tags to include “chronically overweight”, “male”, and “female” private tags 408. These private tags 408 would not be accessible by the producer 102 of the specific audio file nor by the individual users accessing the specific audio file. One reason for limiting knowledge of the keywords used as private tags 408 is that: the producer 102 of the specific audio file entity Xi may not appreciate or otherwise agree with the association of tags 408 for “chronically overweight”, “male”, and “female” with their entity 400; and/or the individual users may not appreciate or otherwise agree with the explicit labelling of “chronically overweight”, “male”, and “female” included in their sectors Si and entities 302, Xi public profiles 504 (e.g. through public tags 406).

A further example of selecting private tags 408 to associate with a sectors Si and/or entities 302, Xi is using behavioural analysis of a selected user 104. For example, behavioural information 414 related to the selected user 104 could include information such as but not limited to: history of access to certain sectors Si and entities 302, Xi including entity type and frequency/timing of access; history of access to new sectors Si and entities 302, Xi not from the usual certain sectors Si and entities 302, Xi; identification details of the browser 207 and/or of device 101 of the user—see FIG. 5; information on the user and/or user device 101 obtained from a third party information database (not shown)—example air miles or other reward programs; browsing behaviour and/or user profile, shopping profile, or other user profile data not included in the public tags 406; or a combination thereof. It is recognised that browsing behaviour can include behaviour 414 such as but not limited to: user clicks (on-click event) on a link or performs some other user action (e.g. mouse-over/hover event) during interaction with selected sectors Si and entities 302, Xi of the connection view 300 obtained from prior search results 106; type of online ads interacted with; number of interactions with selected sectors Si and entities 302, Xi displayed in the connection view 300; the amount of time spent interacting with a particular entity Xi; etc.

The behavioural information 414 of the user 104 can be monitored by the framework 108, can be supplied to the framework 108 by a third party, or a combination thereof. Again, in the context of user 104 profiling 504, it is recognised that the users 104 may not appreciate the association of certain tags 405 to their sectors Si and entities 302, Xi description (e.g. user profile 504), hence the usefulness of private tags 408 to embody the known behavioural information 414 of the user 104. Accordingly, access to private tags 408 details, that are part of the tag cloud 502 for a respective sectors Si and entities 302, Xi, is restricted by the framework 108 for those individuals/organizations that are external or are otherwise not associated/related to the framework 108.

### Computing Devices 101

Referring to FIGS. 1 and 5, each of the above-described components of the system 10, i.e. the producer 102, the framework 108, the user 104, the search engine 110 and hosting devices 101 of the entities Xi, can be implemented on one or more respective computing device(s) 101. The devices 101 in general can include a network connection interface 200, such as a network interface card or a modem, coupled via connection 218 to a device infrastructure 204. The connection interface 200 is connectable during operation of the devices 101 to the network 11 (e.g. an intranet and/or an extranet such as the Internet), which enables the devices 101 to communicate with each other as appropriate. The network 11 can support the communication of the search request 105 and the corresponding search results 106 between the components of the system 10.

Referring again to FIG. 5, the devices 101 can also have a user interface 202, coupled to the device infrastructure 204 by connection 222, to interact with a user (e.g. producer 102, user 104, search engine 110 administrator, framework 108 administrator, etc.). The user interface 202 is used by the user 104 of the device 101 to view and interact with the connection view 300. The user interface 202 can include one or more user input devices such as but not limited to a QWERTY keyboard, a keypad, a trackwheel, a stylus, a mouse, a microphone and the user output device such as an LCD screen display and/or a speaker. If the screen is touch sensitive, then the display can also be used as the user input device as controlled by the device infrastructure 204. For example, the user interface 202 for the devices 101 used by the users 104 can be configured to interact with a web browsers (e.g. applications 207) to formulate the search requests 105 as well as process the received search results 106 (e.g. navigation of the interconnections 304 of the displayed secondary entities Xi in the connection view 300). For the devices 101 used by the framework 108, the user interfaces 202 can be used by a framework 108 administrator to associate (e.g. manually or automated through association software—e.g. applications 207) the tags 405 with the user 104 and/or the entities 400, as further described below.

Referring again to FIG. 5, operation of the devices 101 is facilitated by the device infrastructure 204. The device infrastructure 204 includes one or more computer processors 208 and can include an associated memory 210 (e.g. a random access memory). The computer processor 208 facilitates performance of the device 101 configured for the intended task through operation of the network interface 200, the user interface 202 and other application programs/hardware 207 of the device 101 by executing task related instructions. These task related instructions can be provided by an operating system, and/or software applications 207 located in the memory 210, and/or by operability that is configured into the electronic/digital circuitry of the processor(s) 208 designed to perform the specific task(s). Further, it is recognized that the device infrastructure 204 can include a computer readable storage medium 212 coupled to the processor 208 for providing instructions to the processor 208 and/or to load/update client applications 16. The computer readable medium 212 can include hardware and/or software such as, by way of example only, magnetic disks, magnetic tape, optically readable medium such as CD/DVD ROMS, and memory cards. In each case, the computer readable medium 212 may take the form of a small disk, floppy diskette, cassette, hard disk drive, solid-state memory card, or RAM provided in the memory module 210. It should be noted that the above listed example computer readable mediums 212 can be used either alone or in combination. The device memory 210 and/or computer readable medium 212 can be used to store the profile 504 information of the user 104 of the device 101, such that the profile 504 information is used in processing of the search requests 105 submitted from the device 101 to the network 11. Further, the device memory 210 can also be used by the framework 108 as a means to store and access profile 503,504 information of entities 302,Xi and/or sectors Si that are associated with the search request 105.

Further, it is recognized that the computing devices 101 can include the executable applications 207 comprising code or machine readable instructions for implementing predetermined functions/operations including those of an operating system, a web browser, the framework 108 for example. The processor 208 as used herein is a configured device and/or set of machine-readable instructions for performing operations as described by example above. As used herein, the processor 208 may comprise any one or combination of, hardware, firmware, and/or software. The processor 208 acts upon information by manipulating, analyzing, modifying, converting or transmitting information for use by an executable procedure or an information device, and/or by routing the information with respect to an output device. The processor 208 may use or comprise the capabilities of a controller or microprocessor, for example. Accordingly, any of the functionality of the framework 108 (e.g. modules 402, 404, 407, 410, 411, 412, and subset thereof may be implemented in hardware, software or a combination of both. Accordingly, the use of a processor 208 as a device and/or as a set of machine-readable instructions is hereafter referred to generically as a processor/module for sake of simplicity. Further, it is recognised that the framework 108 can include one or more of the computing devices 101 (comprising hardware and/or software) for implementing the modules 402, 404, 407, 410, 411, 412, or functionality subset thereof, as desired.

It will be understood that the computing devices 101 of the users 104 may be, for example, personal computers, personal digital assistants, mobile phones, and content players. Server computing devices 101 can be configured for the framework 108, producers 102, entity 400 hosting devices, and search engine 110) as desired. Further, it is recognised that each server computing device 101, although depicted as a single computer system, may be implemented as a network of computer processors, as desired.

### Example Navigation of Connection Views 300,350

Referring to FIGS. 1 and 2, the primary connection view 300 (initially provided to the user 104 as a result of the search request 105 having the user 104 included as the primary entity 302) has four sectors Si, namely a first quadrant labelled Publishers (e.g. defined by a list of publisher tags 405), a second quadrant labelled Authors (e.g. defined by a list of author tags 405), a third quadrant labelled Titles (e.g. defined by a list of title tags 405), and a fourth quadrant labelled Genre (e.g. defined by a list of preferred genre tags 405). The search request 105 included search parameters 99 pertaining to literary works and the defined sectors S2, S3, S4 (e.g. either by sector name/type or list of definitions/tags 405). The corresponding search results 106 included; the matched sector S1 on publishers (for example in view of the interconnections 306 between the entities X1, X2, X3), the other three sectors S2, S3, S4 as specified; the secondary entity X1 representing a blog about literary works; the entity X2 representing another user of the framework 108; the entity X3 representing a particular book list; the entity X4 representing a particular book; and the entity X5 representing a book club (e.g. a group of users of the framework 108).

Further, upon inspection of the interconnections 304 present in the connection view 300, it can be determined that: the user X2 is a member of the blog X1 (in view that the entity X1 is connected to the entity X2 by the displayed interconnection 304—e.g. a line); the book list X3 contains at least some of the publishers (present in the definitions of the sector Publishers) or that the blog X1 subscribes to or otherwise published the book list X3 (in view that the entity X3 is connected to the entity X1 by the displayed interconnection 304—e.g. a line); and the particular book X4 has been read by the user X2 or that a review of the book X4 has been published by the user X2 (in view that the entity X4 is connected to the entity X2 by the displayed interconnection 304—e.g. a line). Further, the user 302 could also make the characterization that the user X2 is not a published member of the book club X5, the book club X5 does not have any experience with the book X4, the book club X5 is not connected to the book list X3, and no members of the book club X5 participate in the blog X1. Accordingly, the displayed interconnections 304 provide for visual discernment of potential relations between the displayed secondary entities Xi. Further, it is also recognised that the descriptive summary 308 (e.g. via text and/or symbols/icons) of the interconnection 304 can be displayed (for example in response to a mouse-over or other user event 109 via a user interface 202—see FIG. 5) adjacent to the selected interconnection 304, thus facilitating an understanding of the interconnection 304 by the user of the device 101.

It is recognised that the displayed contents of the connection view 300 could have been limited by the search request 105 or by preset conditions (via the user 104 and/or framework 108) to a specified number (minimum and/or maximum) of secondary entities Xi and/or sectors Si and/or interconnections 304. It is also recognised that only those secondary entities Xi that fall within the defined extents of the sectors Si (i.e. within the external boundaries 303) may be displayed in the connection view 300, however an indication can be provided to the user 104 that indicates the number and/or type of secondary entities Xi and/or interconnections 304 not displayed in the sectors Si.

Upon inspection of the relative positioning of the secondary entities Xi within the sectors Si, one could visually discern that the blog X1 probably contains/refers to a larger degree/number of publishers (with respect to the definition of the sector Publishers) than the authors, titles, genre of their corresponding sector Si definitions. However, of the remaining sectors Si, the blog X1 also contains a greater degree/number of titles (hence positioned closer to sector Titles than sector Authors) than authors and a greater degree/number titles and authors than genre. Further, the blog X1 is also the closest (i.e. shortest relative distance 306) to the user 302 as compared to the other entities X2, X3, X4. Accordingly, the user 302 (upon inspection of the connection view 300) that the blog X1 is most closely related (e.g. having similar interests) to the user 302 out of all the secondary entities Xi and that this degree of relatedness concerns primarily the named publishers (of the sector Publisher definition) with secondary relatedness considerations of the named authors and titles (of the sector Titles and Authors definitions respectively).

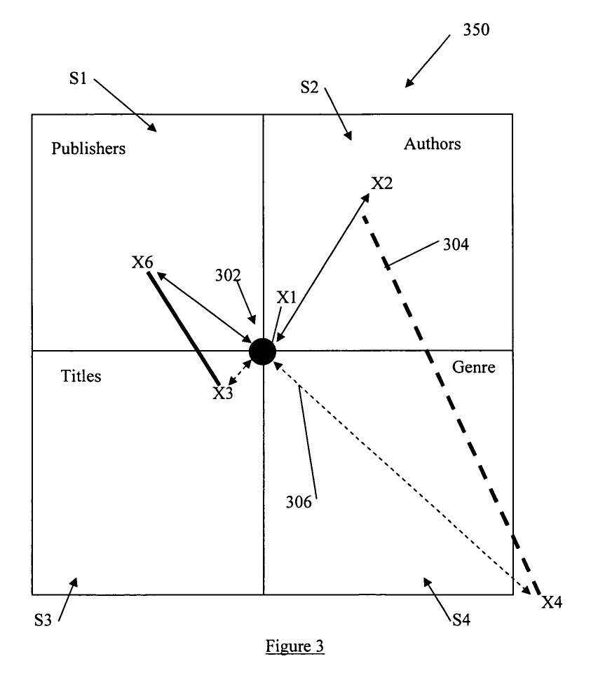

Accordingly, the user 302 can now begin to navigate the entity network view shown in FIG. 2 that pertains to the search parameters 99 (as well as optional tags 405 used by the framework 108) based on the primary entity 302 (in this case the user). The user 302 could decide to select the secondary entity X1 from the connection view 300 (i.e. the primary connection view) of FIG. 2 to see what other entities Xi are related to it, i.e. what is the secondary connection view 350 of the entity X1 as the primary entity 302—which would pertain to an entity network view 350 based on the entity X1 as the primary entity 302 (see FIG. 3).

Referring to FIG. 3, shown is the resultant connection view 350 (i.e. the secondary view) based on the blog entity X1 as the primary entity 302. In this example, all of the sectors S1,S2,S3,S4 remain the same between the views 300, 350. It should be noted that the interconnections 304 pertaining to the secondary entities X2 and X3 result in these entities being included in the connection view 350, with appropriate degrees of similarity based on the recalculated distances 306 to the entity X1 as the primary entity 302. It should also be noted that the interconnection 304 between X2 and X4 is shown in ghosted view (e.g. not an explicit part of the display contents of the view 350), since the corresponding distance 306 places the entity X4 outside of the external boundaries 303 of the sectors Si. Accordingly, one could determine from the view 350 that omission of entity X4 signifies that the entities X1 and X4 are only distantly related. Further, it looks like the book list entity X3 is the most closely related to the entity X1 out of all the displayed secondary entities Xi. Further, the view 350 also contains a new secondary entity X6, for example another literary blog, that also has publishers in common with the definitions of the sector Publisher. From this, the user 104 could ascertain that this new blog X6 is connected to the blog X1 and therefore the new blog X6 may be of interest to the user 104, in particular since this new blog X6 also has an interconnection 304 to the same book list entity X3.

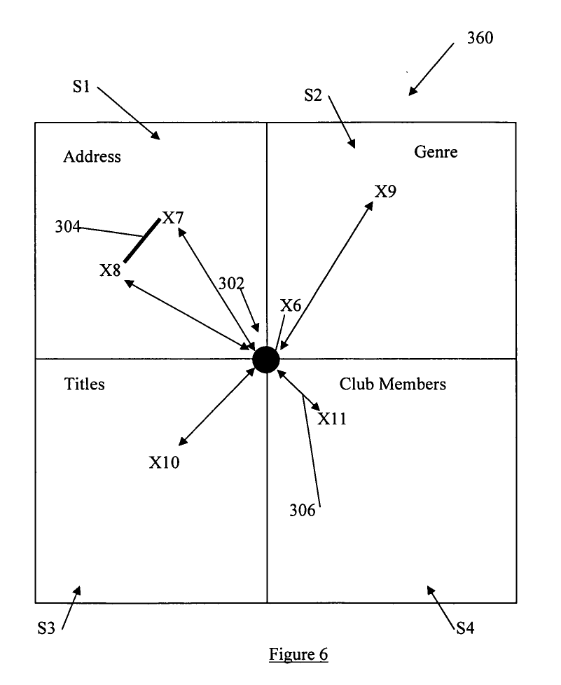

Further navigation of the view 350 by the user can be done by selecting the new blog X6 as the primary entity 302, as shown in the connection view 360 of FIG. 6. In this view 360, the user 104 wanted to particularly determine potential members of the blog X6 and therefore specified a change in the sectors Si used to construct the view 360 for now only member names (as the secondary entities Xi), namely sector Address, sector Titles, sector Book Club Members, and sector Genre. The resulting view 360 shows a plurality of specific member entities X7, X8, X9, X10, X11 that are related to the blog X6 as member entities Xi and also match (to a certain degree) the definitions of the other sectors Si. For example, the user can now see that member entities X7 and X8 of the blog X6 have addresses in a similar region to those specified in the sector Address (and also have a personal interconnection 304 as well), member entity X10 is somewhat related to the sector Address but predominantly has the best match for the list of titles of the sector Titles definition(s), member entity X9 also is somewhat related to the sector Address but predominantly has the best match for the list of genres of the sector Genre definition(s), and entity member X11 of the blog X6 is relatively active member of the blog X6 for a number of book clubs but is not particularly located in a similar region to those specified in the sector Address.

Accordingly, in view of the above discussion, the user 104 of the entity framework 108 can obtain different connection views 300,350,360 pertaining to; specified search parameters 99, selected secondary entities Xi as the next primary entity 302, specified types of secondary entities Xi (e.g. include member entities only, exclude Websites or other specified entity types or names/categories, etc.), specify the same (e.g. name, definition, and/or type) or different (e.g. name, definition, and/or type) sectors Si for use in the view 300,350,360, and restate certain limits/thresholds 309, 310 (see FIG. 1), for example. Further, it is recognised that the framework 108 can dynamically change the private tags associated with the user 104 and/or any of the entities Xi during navigation of the various views 300, 350, 360, thus providing for potentially different degrees of relevancy for the same entities in different view contents. For example, if the user 104 desires to reproduce an earlier search request 105, the resultant connection view 300 may be different with respect to actual content of the initial connection view 300.

### Entity Framework 108

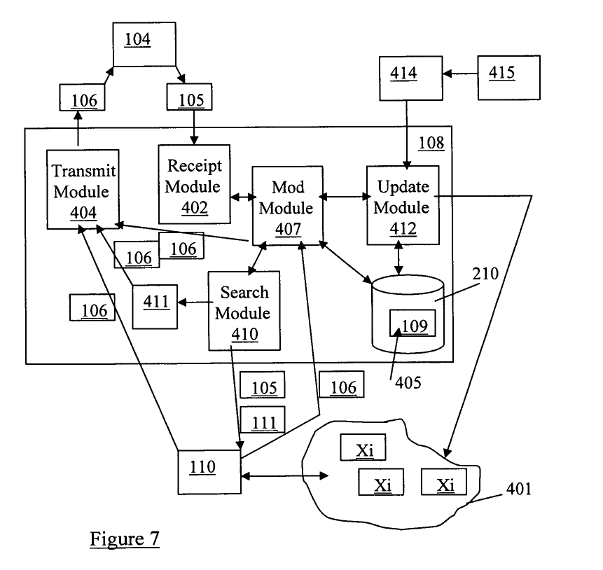

Referring to FIG. 7, shown is one embodiment of the entity framework 108 for processing of search requests 105, providing search results 106 including the generated connection views 300, and updating of the tag clouds 502 of respective entities 302, Xi as well as the contents of the connection view 300 (e.g. as different views 350,360), for example.

The Framework 108 includes a receipt module 402 for receiving the search requests 105 for processing, and a transmit module 404 for sending the corresponding search results 106 to the user 104. The transmit module 404 (or a generation sub-module thereof) can also be responsible for generating the connection view 300 that corresponds with the sector Si and entity Xi results or can submit the sector Si and entity Xi result data for rendering as the connection view 300 on the device 101 of the user 104. A request matching module 407 receives the search request 105 from the receipt module 402 and identifies the corresponding user profile 504, the specified sector Si profiles 503, and/or the primary entity 302 profile 504 from the user table 109 in storage 210. The matching module 407 can then amend the parameters 99 (see FIG. 1) of the search request 105 by adding additional parameters 99 according to the contents of the private tags 408 and optionally the public tags 406 of the profiles 503,504. A potentially modified search request 111 is then sent to a search module 410, which interacts optionally with an external search engine 110 (and/or performs the entity search itself) in order to obtain secondary entities Xi and/or sectors Si that best match the search request 111. Also included is an update module 412 configured for monitoring or otherwise receiving behavioural information 414 (and/or inspecting the tag clouds 502 of the entities Xi, 302 of the search results 106) of selected entities Xi, determining appropriate private tags 408 (and/or public tags 406) representing predefined changes to the content of the tag clouds 502, as given by example above, and then updating/creating/deleting private tags 408 (and/or public tags 406) associated with the corresponding entity Xi and/or sectors Si in the table 109. The update module 412 (or matching module 407) can also be configured (or alternatively configured) for updating the first search request 105 submitted by the user 104 as a second search request to result in a further desired secondary connection view 350,360 based on navigation of the previous primary connection view 300.

Also included can be a generator module 411 for generating the connection view 300 as a rendered display or as display data that can be used to subsequently render the connection view 300 display, as desired, including the primary entity 302 and at least one of the matched secondary entities Xi having an entity profile 504 stored in the storage 210. Accordingly, it is recognised that the search results 106 can contain entities Xi that are registered with the framework 108 or a combination of registered and non-registered entities Xi. In the case of non-registered entities Xi, it is recognised that these non-registered entities Xi (i.e. with the framework 108) may not have a profile 504 (as noted for the registered entities Xi) and/or may not have associated private tags 408.

### Receipt Module 402

The receipt module 402 can be part of the network connection interface 200 (see FIG. 5) of the device 101 operating the framework 108. The module 402 can communicate synchronously or asynchronously with the device 101 of the user 104 over the network 11.

### Transmit Module 404

The transmit module 404 can be part of the network connection interface 200 (see FIG. 5) of the device 101 operating the framework 108. The module 404 can also communicate synchronously or asynchronously with the device 101 of the user 104 over the network 11, in accordance with the parameters 99 of the search request 105 as well as the configuration of the receipt module 402, as desired.

The transmit module 404 (or a sub-module thereof, for example) could also direct that the search results 106 be saved as a save state of the resultant connection view 300. It is recognised that due to the dynamic evolution of the tags 405 of the profiles 503,504, a new search request 105 using the parameters 99 from an earlier request 105 may not produce identical search results 106 (e.g. identical connection view 300) to that of the earlier search request 105. Accordingly, a save state of any connection view 300 could save the contents of the connection view 300 and/or could save all of the parameters 99 and historical tag 405/profile 503,504 information used to generate the connection view 300. In this event, earlier obtained search results 106 (e.g. the connection view 300) could be recreated, as desired by the user 104.

### Request Matching Module 407

Referring again to FIG. 7, one embodiment of the matching module 407 is to amend the parameters 99 of the search request 105 by analysing the tag cloud 502 of the entity 302,Xi (e.g. user 104 initiating the request 105 or the specified primary entity 302). The modified search request 111 would then be sent to the search engine 110, for example, in order to obtain search results 106 consistent with the modified search request 111.

A further embodiment of the module 407 is where the unmodified search request 105 is first sent to the search engine 110 to determine entities Xi matching the search parameters 99. Upon receipt of the search results 106, the module 407 uses the private tags 408 of the user 104 and/or the primary entity 302 and the sectors Si to modify or otherwise rank the degree of relatedness/match of the entities Xi in the search results 106 (see FIG. 1). This modified search result 106 could then be used to generate the connection view 300 that is then sent back to the user 104, for example via the generation module 411. For example, the user 104 indicated in the search parameters 99 of the search request 105 that they would like to see book reviews related to a named book. Upon receiving the search results 106, the module 407 notes that the user has private tags 408 indicating preferences for other interests related to this book and books in general. The module 407 would then reorder the search results 106 based on these private tags 408, thus providing the connection view 300 with one or more entities Xi that are related to the named book and also accord to the user specified sectors Si as well as any matched sectors Si, if applicable.

An example of the entity Xi categories/sectors Si would be such as but not limited to: the top ten articles including the other named books pertaining to interests of the user 104; the top ten (e.g. based on the set limits/thresholds 309,310) blogs pertaining to the named book and other related books; the top book lists of the named celebrities; the top ten blogs having entries pertaining to the named book; the top ten member entities (e.g. other users 104) that purchased the named book; etc. It is noted that the search results 106 can have a variety of mixed entity types 404 (see FIG. 4), as desired, as well as a plurality of categories/sectors Si based on the initial search terms 99 of the search request 105 as well as the private tags 408 of the user 104 and/or the entities Xi and the primary entity 302.

A further embodiment of this module 407, for example, is to provide a snapshot view 320 (see FIG. 2) of a further connection view 300 associated with the selected secondary entity Xi. For example, the snapshot 320 is shown as a miniature view of the connection view of FIG. 3, such that the snapshot view 320 is what would subsequently be produced by the framework 108 if the selected secondary entity Xi were repositioned as the primary entity 302. The snapshot view 320 could be used by the user 104 to straightforwardly determine which of the secondary entities Xi should be selected next in navigation of the original connection view 300.

It is recognised that, as discussed above, the profile information 504 used to generate the snapshot view 320 could be from the user 104 only, from the secondary entity Xi only, or a combination of both profiles 504. For example, the snapshot view 320 could portray the connection view 300 as if the secondary entity Xi was the user 104 submitting the search request 105. The snapshot view 320 could be generated as a new specific search request 105 constructed by the user (e.g. through the use of a pop-up box positioned adjacent to the selected secondary entity Xi and requiring the input of further search information—such as additional search parameters 99 and/or selection of profile information). Alternatively, the snapshot view 320 could be automatically generated in response to selection (e.g. by user 104 events such as a mouse/roll over of the displayed secondary entity Xi) of the secondary entity Xi using predefined parameters for generating the snapshot views 320.

It is also recognised that the module 407 can be used to modify the first search request 105 (resulting in the primary connection view 300) as the secondary search request 105 (resulting in the primary connection view 300). This modification is performed by substituting one of the secondary entities Xi (from the view 300) as a revised primary entity 302 for the second search request 105, such that the secondary connection view 350 is generated as a navigation of the primary connection view 300 such that the secondary connection view 350 has the revised primary entity 302 and at least one further secondary entity Xi of the group of entities matching the second search request (e.g. according to a corresponding predefined inclusion threshold 310).

### Search Module 410

The search module 410 communicates with the search engine 110 (or a plurality of search engines—not shown) in order to facilitate obtaining of search results 106 that are most relevant to the user 104. The search engine 110 can be part of the search module 410 and/or linked to the search module 410 via the network 11.

The search engine 110 can be referred to as a coordinated set of programs that can include: a spider that goes to every page or representative pages on every Web site that wants to be searchable and reads it, using hypertext links on each page to discover and read a site's other pages; a program that creates a huge index (sometimes called a “catalog”) from the pages that have been read; and/or a program that receives the search request 105 (or modified request 111, compares it to the entries in the index, and returns results in the form of the search results 106, for example. The search can also include an exploration of a structured directory of topics. The search engine 110 can also be provided as a number of Web portal sites that offer both the search engine 110 and directory approaches to finding information pertaining to the search terms 99 and/or the corresponding profiles 503,504(see FIG. 4).

It is recognised that specialized content search engines 110 can be utilized by the framework 108, which are selective about what part of the Web is crawled and indexed. It is recognised that the private tags 408 could also be attached to the profile of the specialized search engines 110 based on their speciality. For example, entities xi obtained from a search engine 110 that typically pertain predominantly to peer book reviews could be tagged by associating a private tag 408 directly to network 11 address associated with the search engine 110. In this case, it is recognised that the search engines 110 could also be included in the entity table 109 along with their private tags 408, as desired. It is also recognised that the search engines 110 may be configured for Extranet searching (e.g. individual Internet Web sites) as well as for intranet searching (e.g. larger corporate sites).

### Update Module 412

Referring again to FIG. 7, the update module 412 is responsible for receiving the behavioural information 414 and for modifying the private tags 408 of the corresponding entities Xi in the entity table 109, as described by example above. For example, media entities Xi provided by the producers 102 (see FIG. 1), and suggested public tags 406 therefore, would initiate a tag 406 entry in the table 109. Based on monitored behavioural interaction with the tagged media entity Xi by the users 104, updates to the corresponding private tags 408 (and/or public tags 406) would be done. Also, based on popularity of certain noted entities Xi, the update module 412 could decide to start monitoring behavioural interaction with the noted entities Xi and input corresponding tag entries into the table 109.

For example, in the case where the user 104 searched for other users as entities Xi (e.g. peer reviewers), the private tags 408 of the other users would be modified by the update module 412. These updates would be based on the behavioural information 414 of the user 104 who initiated the search request 105 and/or tag cloud 502 content of the entities Xi in the search results 106. For example, the user 104 may have certain tags 405 (public and/or private) that would be used to update the private tags 408 of the user entity 400 found during a search.

A further example is where a particular user 104 decides to register with the entity navigation framework 108. The user 104 would provide their initial profile 504 through public tags 406. The update module 412 would then initiate a tag 405 entry in the table 109 for the particular user 104. Based on monitored behavioural information 414 and/or search results 106 of the particular user 104, updates to the private tags 408 of the particular user 104 would be done. These updates could be done on a periodic basis by first collecting of otherwise monitoring the behavioural information 414 and/or search results 106 pertaining to the user 104 over a period of time (e.g. predefined by the framework 108). Analysis of the collection of behavioural information 414 and/or search results 106 by the update module 412 would be used to generate new private tags 408 and thereby amend the tag 406,408 entries of the user 104 in the table 109.

It is recognised that providing the registration information of the users 104 and/or producers 102 to the framework 108 can be done over the network 11. The communication of the registration information can include communication modes such as but not limited to: voice communication via phone; written communication via network messaging (e.g. email, facsimile); and/or others as desired.

It is recognised that the users 104 and/or the producers 102 registered with the framework 108 could be issued framework ID and password (optional), which uniquely identifies the particular user 104/producer 102. The framework ID could be associated with the tag entries in the table 109, thus facilitating updates of the public tags 406 by the users 104 and/or the producers 102 for corresponding entities Xi. This can be accomplished by a registration module (e.g. an update module 412—see FIG. 7) in communication with the user 104 and/or producer 102, as desired.

Further, it is recognised that the modules 402,404,407,410, 411, 412 can be configured to operate interactively as shown, the operations/functionality of the selected modules 402,404,407,410, 411, 412 can be combined or the operations/functionality of the selected modules 402,404,407,410, 411, 412 can be further subdivided, as desired. Further, it is recognised that the modules 402,404,407,410, 411, 412 can communicate or otherwise obtain their calculated results from one another or can store their respective calculated results in the storage 210 for subsequent retrieval by another module 402,404,407,410, 411, 412 there-from.

### Operation 500 of the Framework 108

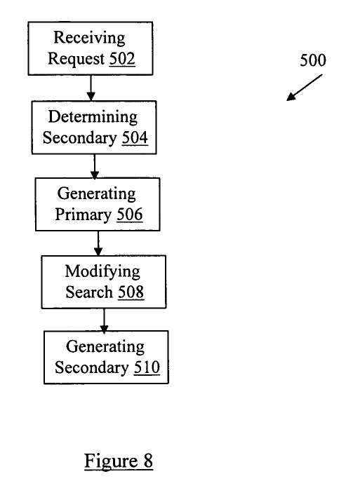

Referring to FIGS. 1 and 8, the framework 108 provides for navigation of the connectedness of selected entities Xi, 302 of the group of entities 401 via the connection views 300,350 adapted for display on the user interface 202 (see FIG. 5). The operation 500 includes the steps of: receiving 502 by the receipt module 402 a first search request 105 for determining one or more secondary entities Xi of the group of entities 401 in relation to the specified primary entity 302; determining 504 via the search module 410 the secondary entity Xi as matching the first search request 105 according to a predefined inclusion threshold 310; and generating 506 by the generation module 411 a primary connection view 300 including a domain having a plurality of sectors Si, the connection view 300 for use in providing a visual discernment by the user 104 of a degree of relatedness between the primary entity 302 and the secondary entity Xi and a relationship between the secondary entity Xi and each of the plurality of sectors Si. Further, the operation 500 can include modifying 508 by the matching module 407 of the first search request 105 as the second search request 105 by substituting the determined secondary entity Xi as a revised primary entity 302 for the second search request 105. Subsequently, the secondary connection view 350 is generated 510 as a navigation of the primary connection view 300, such that the secondary connection view 350 has the revised primary entity 302 and at least one further secondary entity Xi of the group of entities 401 matching the second search request 105, according to the corresponding predefined inclusion threshold 110, for example.

It is also recognised that the matching module 407 can modify the first search request 105 by including at least a portion of the profile 504 information of the primary entity (e.g. the user 104) for use with the search parameter 99 in the matching by the search module 410. The matching module 407 can modify the second search request 105 by including at least a portion of the profile 504 information of the revised primary entity 302 for use in the matching of the second search request 105 by the search module 410.

We claim:

1. A framework providing for navigation of the connectedness of selected entities of a plurality of entities adapted for display on a user interface, the system comprising:
a receipt module for receiving a first search request for determining a secondary entity of said plurality of entities in relation to a primary entity of said plurality of entities, the first search request including at least one search parameter associated with the primary entity for use in determining the secondary entity from said plurality of entities;
a search module for determining the secondary entity as matching the first search request according to a predefined inclusion threshold;
a generation module for generating a primary connection view including a domain having a plurality of sectors, the connection view for use in providing a visual discernment by a user of a degree of relatedness between the primary entity and the secondary entity and a relationship between the secondary entity and each of the plurality of sectors, such that the secondary entity is positioned in the domain in one of the plurality of sectors and the primary entity is positioned in the domain in a position related to said each of the plurality of sectors; and
a matching module for modifying the first search request as a second search request by substituting the determined secondary entity as a revised primary entity for the second search request;
wherein a secondary connection view is generated as a navigation of the primary connection view such that the secondary connection view has the revised primary entity and at least one further secondary entity of said plurality of entities matching the second search request according to a corresponding predefined inclusion threshold.

2. The framework of claim 1 further comprising a storage for assigning respective profile information to entities of said plurality of entities, each of the profile information including at least one profile parameter defining a characteristic of the respective entity of said plurality of entities.

3. The framework of claim 2, wherein the storage is a table correlating the respective profile information to each of the entities in the table.

4. The framework of claim 2, wherein the matching module is further configured to modify the first search request by including at least a portion of the profile information of the primary entity for use with the search parameter in said matching by the search module.

5. The framework of claim 4, wherein the primary entity is the user coupled to the framework over a communications network.

6. The framework of claim 2, wherein the matching module is further configured to modify the first search request by including at least a portion of the profile information of the user submitting the first search request over a communications network, the user profile information for use with the search parameter in said matching by the search module.

7. The framework of claim 2, wherein the matching module is further configured to modify the second search request by including at least a portion of the profile information of the revised primary entity for use in the matching of the second search request by the search module.

8. The framework of claim 7, wherein the revised primary entity is a different user to said user.

9. The framework of claim 2, wherein an entity type of said plurality of entities is selected from the group comprising: a user registered in the framework; a named organization registered in the framework; image media; video media; audio media; textual media; a Web site; an electronic document; a citation of a document; a review; a blog; a group; and a podcast.

10. The framework of claim 2, wherein the profile parameter is a tag for providing the characteristic as entity information selected from the group comprising: the entity identifier; the entity type; a description of the entity; and a label of the entity.

11. The framework of claim 10, wherein the tag is selected from the group comprising: a keyword; a term; and a phrase.

12. A method providing for navigation of the connectedness of selected entities of a plurality of entities adapted for display on a user interface, the method comprising:
receiving a first search request for determining a secondary entity of said plurality of entities in relation to a primary entity of said plurality of entities, the first search request including at least one search parameter associated with the primary entity for use in determining the secondary entity from said plurality of entities;
determining the secondary entity as matching the first search request according to a predefined inclusion threshold;
generating a primary connection view including a domain having a plurality of sectors, the connection view for use in providing a visual discernment by a user of a degree of relatedness between the primary entity and the secondary entity and a relationship between the secondary entity and each of the plurality of sectors, such that the secondary entity is positioned in the domain in one of the plurality of sectors and the primary entity is positioned in the domain in a position related to said each of the plurality of sectors;
modifying the first search request as a second search request by substituting the determined secondary entity as a revised primary entity for the second search request; and
generating a secondary connection view as a navigation of the primary connection view such that the secondary connection view has the revised primary entity and at least one further secondary entity of said plurality of entities matching the second search request according to a corresponding predefined inclusion threshold.

13. The method of claim 12 further comprising assigning respective profile information to entities of said plurality of entities, each of the profile information including at least one profile parameter defining a characteristic of the respective entity of said plurality of entities.

14. The method of claim 13 further comprising modifying the first search request by including at least a portion of the profile information of the primary entity for use with the search parameter in said matching by the search module.

15. The method of claim 13 further comprising modifying the second search request by including at least a portion of the profile information of the revised primary entity for use in the matching of the second search request by the search module.

16. The method of claim 12, wherein the degree of relatedness is a displayable distance in the domain of the primary connection view between the primary entity and the determined secondary entity.

17. The method of claim 16, wherein the relationship between the determined secondary entity and each of the plurality of sectors is defined by a respective distance between the second entity position and each adjacent sector to said one of the plurality of sectors.

18. The method of claim 13 further comprising generation of a snapshot view as a preview of the secondary connection view.

19. The method of claim 18 further comprising substituting the respective profile information of the secondary entity, as the revised primary entity, for that of the user in generation of the secondary connection view.
